(19) United States
(12) Patent Application Publication
(10) Pub. No.: US 2026/0118741 A1
(43) Pub. Date: Apr. 30, 2026

(54) CAMERA MODULE

(71) Applicant: SAMSUNG ELECTRO-MECHANICS CO., LTD., Suwon-si (KR)

(72) Inventors: Ta Kyoung LEE, Suwon-si (KR); Jung Woo KIM, Suwon-si (KR); Kyeong Jun KIM, Suwon-si (KR); Ah Hyeon IM, Suwon-si (KR); Do Seop HWANG, Suwon-si (KR); Hong Joo LEE, Suwon-si (KR)

(73) Assignee: SAMSUNG ELECTRO-MECHANICS CO., LTD., Suwon-si (KR)

(21) Appl. No.: 19/430,475

(22) Filed: Dec. 23, 2025

Related U.S. Application Data
(63) Continuation of application No. 17/488,455, filed on Sep. 29, 2021.

(30) Foreign Application Priority Data
Sep. 29, 2020 (KR) 10-2020-0127466
Jun. 7, 2021 (KR) 10-2021-0073618

(51) Int. Cl. G03B 17/14; G02B 7/09; G03B 17/12; G03B 17/17; H04N 23/51; H04N 23/54; H04N 23/55

(52) U.S. Cl. CPC G03B 17/14; G02B 7/09; G03B 17/12; G03B 17/17; H04N 23/51; H04N 23/54; H04N 23/55

(57) ABSTRACT

A camera module includes: a housing; a lens module configured to move in an optical axis direction in the housing; a first magnetic member disposed in the lens module; and a second magnetic member disposed to oppose the first magnetic member in the housing. The lens module is attached to one surface of the housing by magnetic attraction force arising between the first magnetic member and the second magnetic member. The lens module is supported at three points by three ball members disposed between the lens module and the housing. The first magnetic member is disposed in the lens module such that the first magnetic member is disposed in a triangle formed by virtual lines connecting the three ball members to each other.

### CROSS-REFERENCE TO RELATED APPLICATIONS

This application is a Continuation Application of U.S. patent application Ser. No. 17/488,455 filed on Sep. 29, 2021, which claims the benefit of priorities to Korean Patent Application No. 10-2020-0127466 filed on Sep. 29, 2020 and Korean Patent Application No. 10-2021-0073618 filed on Jun. 7, 2021, in the Korean Intellectual Property Office, the entire disclosures of which are incorporated herein by reference for all purposes.

### BACKGROUND

### 1. Field

This disclosure relates to a camera module and, for example, a structure that may change a path of light collected by a camera at least once.

### 2. Description of Related Art

A camera module provided in a mobile device has been manufactured to have performance comparable to that of a general camera. In particular, as the frequency of capturing images using mobile devices has increased, demand for a camera module that may provide a high zoom magnification has increased.

To increase a zoom magnification, a distance for which light incident to a camera travels to an image sensor, which is a total length or a total track length (TTL), may need to be increased. To implement a relatively long total track length, an overall length of the camera may be increased.

A recently developed camera module may implement a relatively long total track length by changing a path of light entering from a rear surface of a mobile device by about 90 degrees using a reflector such as a prism. However, even in a camera module including a reflector, there may be a limitation in further increasing a zoom magnification.

A zoom magnification may be adjusted by increasing or decreasing a distance between a lens and an image sensor. To provide a wide range of zoom magnification, a movement range of a lens module may need to be increased. However, as a movement distance of a lens module increases, the lens module may move in a direction different from an intended direction or a position of the lens module may not be accurately detected, which may cause an issue in a zoom magnification adjustment function or a focus adjustment function.

In the camera module having a reflective member, an optical image stabilization function may be implemented by rotating the reflective member. However, due to some of the elements necessary for driving the reflective member, it may be difficult to reduce a size of the camera module, or electromagnetic interference with other electronic elements may occur.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes: a housing; a lens module configured to move in an optical axis direction in the housing; a first magnetic member disposed in the lens module; and a second magnetic member disposed to oppose the first magnetic member in the housing. The lens module is attached to one surface of the housing by magnetic attraction force arising between the first magnetic member and the second magnetic member. The lens module is supported at three points by three ball members disposed between the lens module and the housing. The first magnetic member is disposed in the lens module such that the first magnetic member is disposed in a triangle formed by virtual lines connecting the three ball members to each other.

A center of the first magnetic member may be disposed in the triangle.

The lens module may include guide grooves configured to guide the three ball members, respectively, in a direction parallel to the optical axis.

The lens module may include a first support structure extending in the optical axis direction, and a second support structure disposed opposite to the first support structure and extending in the optical axis direction. Two ball members among the three ball members may be disposed between the first support structure and the housing, and another ball member among the three ball members is disposed between the second support structure and the housing. An extension portion protruding farther than the second support structure in the optical axis direction may be formed on the first support structure. One of the two ball members disposed between the first support structure and the housing may be disposed between the extension portion and the housing.

The first magnetic member may be disposed more adjacent to the first support structure than the second support structure.

The lens module may include a lens barrel including at least one lens, and a lens holder accommodating the lens barrel. The extension portion may be a portion of the lens holder.

The lens barrel may be symmetric with respect to a plane that includes the optical axis and is perpendicular to a direction in which the first and second support structures oppose each other.

The camera module may further include: a magnet disposed in the lens module; a coil opposing the magnet; and a position sensor disposed on an external side of the coil.

The camera module may further include: a first reflective member configured to convert a direction of light entering from the outside to a direction toward the lens module; a rotational holder accommodating the first reflective member; and a first driver configured to rotate the rotational holder about a first axis perpendicular to the optical axis. The first driver may include a pair of first magnets disposed in the rotational holder such that the pair of first magnets oppose each other in a direction perpendicular to the first axis, and the first axis is disposed between the pair of first magnets.

The first axis may be perpendicular to the optical axis and parallel to a surface perpendicular to a reflective surface of the first reflective member.

The camera module may further include ball members arranged along the first axis and supporting rotation of the rotational holder. The rotational holder may include a supporting portion on which the ball members are seated, and an extension portion protruding from ends of the supporting portion in a direction parallel to the optical axis. At least a portion of the pair of first magnets may be disposed in the extension portion.

The camera module may further include: a second driver configured to rotate the rotational holder about a second axis perpendicular to both the optical axis and the first axis. The second driver may include a pair of second magnets disposed in the rotational holder such that the pair of second magnets oppose each other in a direction parallel to the second axis.

The second magnets may include a third magnet. The second driver may further include a fifth magnet spaced apart from the third magnet, a coil opposing the third magnet, and a position sensor opposing a boundary between the third magnet and the fifth magnet.

The fifth magnet may be spaced apart from the third magnet in a circumferential direction with respect to the second axis.

The camera module may further include: a first reflective member configured to convert a direction of light entering from the outside to a direction toward the lens module; and a second reflective member configured to convert a direction of light passing through the lens module.

In another general aspect, a camera module includes: a housing; a lens module configured to move back and forth in an optical axis direction with respect to the housing, in the housing; a first magnetic member disposed in the lens module; and a second magnetic member disposed in the housing and opposing the first magnetic member. The lens module is attached to the housing in a first direction perpendicular to the optical axis by magnetic attraction force between the first magnetic member and the second magnetic member, and is supported in the first direction by three support points. The first magnetic member is disposed in a triangle formed by virtual lines connecting the three support points to each other while the lens module moves in the optical axis direction, in a view in the first direction.

The lens module may include a first support structure extending in the optical axis direction, and a second support structure disposed opposite to the first support structure and extending in the optical axis direction. Two support points among the three support points may be disposed between the first support structure and the housing, and another support point among the three support points may be disposed between the second support structure and the housing. An extension portion protruding farther than the second support structure in the optical axis direction may be formed on the first support structure. One of the two support points disposed between the first support structure and the housing may be disposed between the extension portion and the housing.

The lens module may further include a lens barrel including at least one lens, and a lens holder accommodating the lens barrel. The extension portion may be a portion of the lens holder.

In another general aspect, a camera module includes: a housing; a lens module disposed in the housing and configured to move with respect to the housing along an optical axis of the lens module; a first magnetic member disposed in the lens module; and a second magnetic member disposed in the housing and opposing the first magnetic member. The lens module is attached to the housing in a first direction perpendicular to the optical axis by magnetic attraction force between the first magnetic member and the second magnetic member, and is supported in the first direction by three support points. Throughout an entire movement range of the lens module along the optical axis, the first magnetic member is disposed in a triangle formed by virtual lines connecting the three support points to each other in a plane perpendicular to the first direction.

Two support points among the three support points may be disposed on one side of the optical axis, in a direction perpendicular to the first direction. Another support point among the three support points may be disposed on another side of the optical axis, in the direction perpendicular to the first direction.

The two support points may engage a first support structure of the lens module disposed on the one side of the optical axis. The other support point may engage a second support structure of the lens module disposed on the other side of the optical axis. One of the two support points may engage a portion of the first support structure extending beyond the second support structure in an image-side direction of the optical axis.

The three support points may be formed by ball members disposed between the lens module and the housing.

Other features and aspects will be apparent from the following detailed description, the drawings, and the claims.

### BRIEF DESCRIPTION OF DRAWINGS

FIG. 1 is a perspective diagram illustrating a camera module, according to an embodiment.

FIG. 2 is a perspective diagram illustrating the camera module of FIG. 1, in which a cover is not provided, according to an embodiment.

FIG. 3 is a diagram illustrating the camera module of FIG. 1, in which the cover is not provided, as viewed from above, according to an embodiment.

FIG. 4A is an exploded perspective diagram illustrating the camera module of FIG. 1, according to an embodiment.

FIG. 4B is a cross-sectional diagram taken along line I-I′ of FIG. 2, and illustrating a lens module illustrated in FIG. 2.

FIG. 4C is a cross-sectional diagram taken along line II-II′ of FIG. 2, and illustrating the lens module illustrated in FIG. 2.

FIG. 5 is an exploded perspective diagram illustrating a driver of the lens module, according to an embodiment.

FIG. 6 is a diagram illustrating a positional relationship between a support point of the lens module and a magnet in the camera module of FIG. 1, as viewed from above, according to an embodiment.

FIG. 7 is a cross-sectional diagram taken along line III-III′ of FIG. 3.

FIG. 8 is a diagram illustrating the lens module illustrated in FIG. 2, as viewed from the side, according to an embodiment.

FIG. 9 is an exploded perspective diagram illustrating a folded module, according to an embodiment.

FIG. 10 is a diagram illustrating the folded module illustrated in FIG. 9, as viewed from above, according to an embodiment.

FIGS. 11A and 11B are diagrams illustrating the folded module, according to some embodiments.

FIG. 12 is a diagram illustrating stoppers disposed in the camera module of FIG. 1, according to an embodiment.

FIG. 13 is a cross-sectional diagram taken along line IV-IV′ of FIG. 3.

FIG. 14 is a diagram illustrating a camera module in which a direction of light is changed one time, according to an embodiment.

FIG. 15 is a diagram illustrating a portable device including a camera module, according to an embodiment.

Throughout the drawings and the detailed description, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed, as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is to be noted that use of the term “may” with respect to an embodiment or example, e.g., as to what an embodiment or example may include or implement, means that at least one embodiment or example exists in which such a feature is included or implemented while all embodiments and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there are no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape occurring during manufacturing.

The features of the examples described herein may be combined in various ways as will be apparent after an understanding of this disclosure. Further, although the examples described herein have a variety of configurations, other configurations are possible as will be apparent after an understanding of this disclosure.

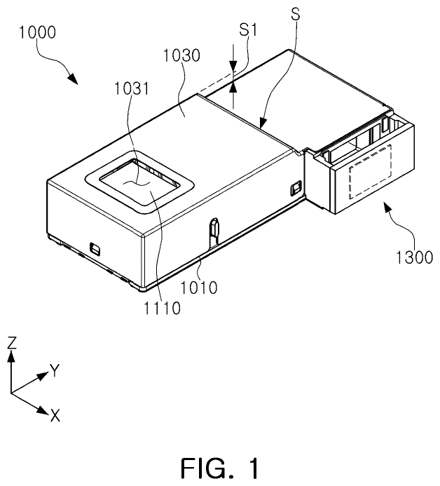

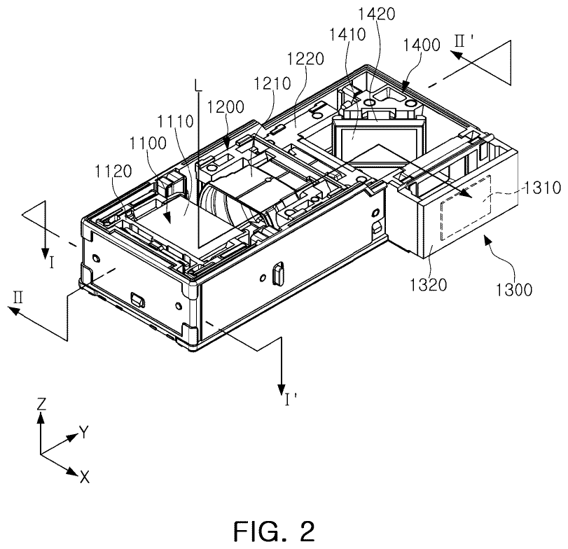

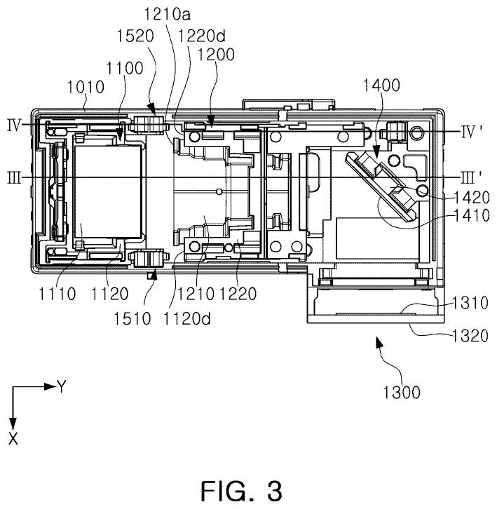

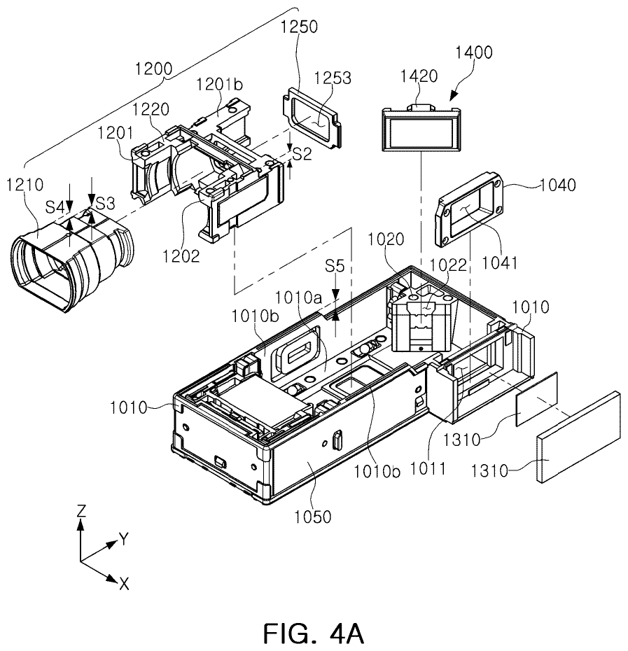

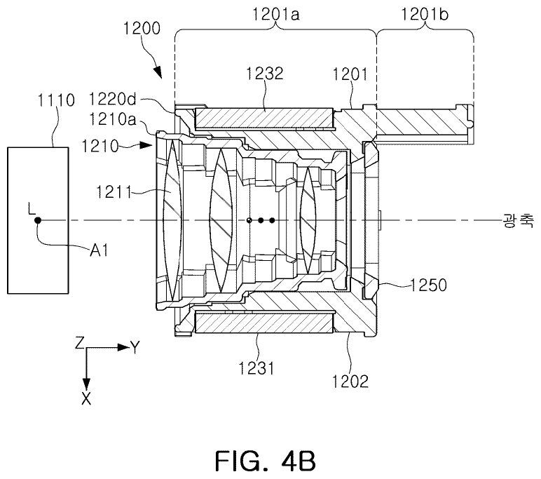

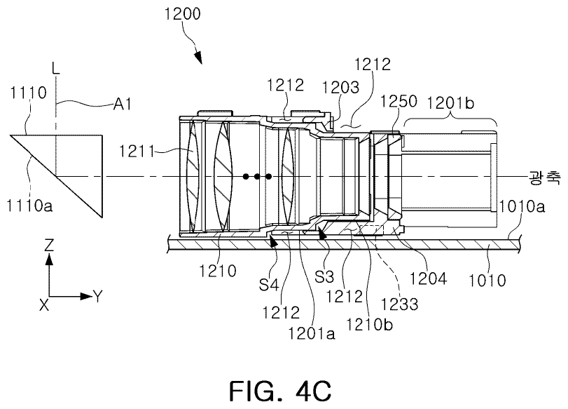

FIG. 1 is a perspective diagram illustrating a camera module 1000, according to an embodiment. FIG. 2 is a perspective diagram illustrating the camera module 1000, in which a cover 1030 is not provided according to an embodiment. FIG. 3 is a diagram illustrating the camera module 1000, in which the cover 1030 is not provided, according to an embodiment. FIG. 4A is an exploded perspective diagram illustrating the camera module 1000, according to an embodiment.

Referring to FIG. 1, an exterior of the camera module 1000 may include a portion of a housing 1010 and a cover 1030. A folded module 1100, a lens module 1200, or an image sensor module 1300 may be provided in a space defined by the housing 1010 and the cover 1030.

Referring to FIG. 1, the cover 1030 may include an opening 1031 configured to receive light therethrough. Light may enter the camera module 1000 through the opening 1031. Referring to FIG. 2, light L entering the opening 1031 may be incident to the reflective member 1110 of the folded module 1100, and the reflective member 1110 may reflect the light L.

Referring to FIGS. 2 and 4A, in an embodiment, the camera module 1000 may include the folded module 1100, a lens module 1200, and the image sensor module 1300.

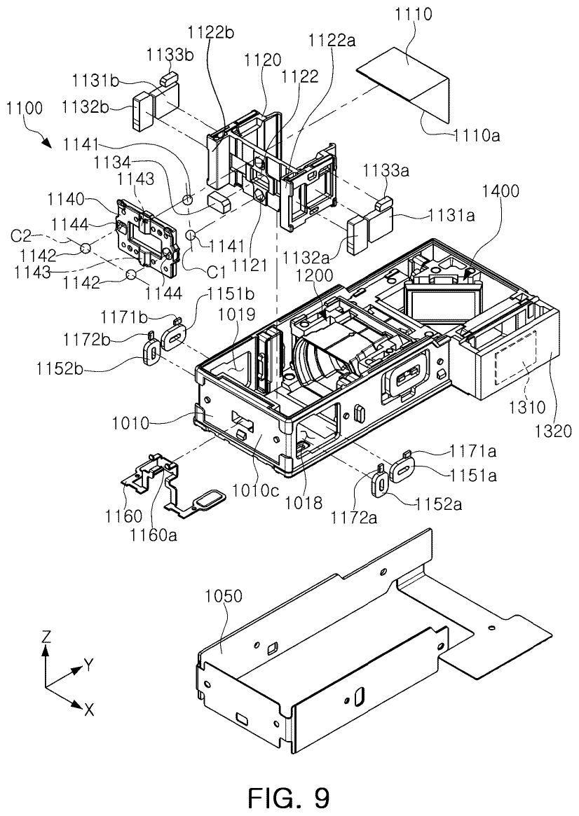

The folded module 1100 may be configured to change a direction of the light L. The light L, which is incident through the opening 1031 of the cover 1030 covering the camera module 1000 from the top, may be converted to be directed to the lens module 1200 through the folded module 1100. For example, the light L may be incident in a thickness direction (Z-axis direction) of the camera module 1000, and may be converted to coincide with, or approximately coincide with, the optical axis (Y-axis) direction by the folded module 1100. The folded module 1100 will be described later in greater detail, with reference to FIGS. 9 to 11.

In an embodiment, the lens module 1200 may refract the light L reflected from the folded module 1100. The lens module 1200 may include a plurality of lenses arranged along an optical axis, and the light L may be refracted while passing through the plurality of lenses.

Referring to FIG. 4A, the lens module 1200 may include a lens barrel 1210 and a lens holder 1220. The lens barrel 1210 may include the plurality of lenses therein. The plurality of lenses may have a circular shape or a shape of which edges are cut-off (e.g., a D-cut lens) on two opposite sides. When the lens barrel 1210 includes D-cut lenses, an exterior of the lens barrel 1210 may also have a shape corresponding to the D-cut lenses.

In an embodiment, the lens barrel 1210 and the lens holder 1220 may be configured as separate elements. For example, after each of the lens barrel 1210 and the lens holder 1220 is manufactured, the lens barrel 1210 and the lens holder 1220 may be coupled to each other.

In an embodiment, the lens module 1200 may further include a baffle 1250 configured to prevent flare. The baffle 1250 may have a frame including a through portion 1253 therein, and may be inserted into the lens holder 1220. A portion of light passing through the lens barrel 1210 may be absorbed by the baffle 1250 or may be diffusely reflected by the baffle 1250, which may prevent or inhibit flare.

The reflective module 1400 may be configured to convert light passing through the lens module 1200 to be directed to the image sensor 1310. Since the camera module 1000 includes the reflective module 1400, a relatively large total track length (TTL) may be provided without significantly increasing the length in the optical axis direction (the length in the Y axis direction). The total track length may be defined as a maximum distance between a lens surface most adjacent to the object side, among the plurality of lenses disposed in the lens module 1200, and a sensor surface of the image sensor. A longer total track length may be advantageous to implement a high zoom magnification, and accordingly, the camera module 1000, by including the reflective module 1400, may provide a relatively high zoom magnification.

In an embodiment, the reflective module 1400 may include a reflective member 1410 and a holder 1420 accommodating the reflective member 1410. The housing 1010 may include a support structure 1020 accommodating the holder 1420. For example, the support structure 1020 may include a groove 1022 extending in one direction, and the holder 1420 may include a structure corresponding to the groove 1022.

In the camera module 1000, the optical path may be changed at least twice by the folded module 1100 and the reflective module 1400. Referring to FIG. 2, the light L incident to the folded module 1100 in the Z-axis direction may be changed to travel in the Y-axis direction by the reflective member 1110, and the light L may thereafter be changed to travel in the X-axis direction by the reflective member 1410 of the reflective module 1400 after passing through the lens module 1200.

In the embodiment illustrated in FIGS. 1 to 4A, a path of the light L passing through the reflective module 1400 may be bent to be directed to the +X direction, and the image sensor may be disposed in the +X direction of the reflective module 1400, but the camera module 1000 is not limited to such a configuration. In other embodiments, the direction in which the reflective module 1400 bends light may be varied. For example, referring to FIGS. 2 and 3 together, in another embodiment, a path of light passing through the reflective module 1400 may be bent to be directed to the −X direction and, in this case, the image sensor module 1300 may be disposed in the −X direction with respect to the reflective module 1400.

For example, as shown in FIGS. 2 to 4A, the image sensor module 1300 may include an image sensor 1310 and a substrate 1320 on which the image sensor 1310 is mounted. The image sensor 1310 may be disposed such that a light collecting surface of the sensor may oppose the reflective member 1410 of the reflective module 1400, and may generate an image signal corresponding to light reflected from the reflective member 1410.

In an embodiment, the image sensor module 1300 may include an optical filter configured to filter light incident from the lens module 1200. The optical filter may include an infrared cut-off filter, for example.

In an embodiment, the housing 1010 may include an internal space configured to accommodate the folded module 1100, the lens module 1200, and the image sensor module 1300. In an embodiment, a portion of the image sensor module 1300 may be provided externally on the housing 1010. For example, the substrate 1320 included in the image sensor module 1300 may be attached to an external side of the housing 1010.

In an embodiment, the housing 1010 may be configured in an integrated form to accommodate the folded module 1100, the lens module 1200, and the image sensor module 1300 in the internal space. However, other embodiments are possible, and in another embodiment, the housing 1010 may have a structure in which multiple housings each configured to accommodate a portion of the folded module 1100, the lens module 1200, and the image sensor module 1300 are connected to each other.

In the illustrated embodiment, the image sensor module 1300 may be disposed in the housing 1010, but in another embodiment, a separate housing configured to accommodate the image sensor module 1300 may be connected to the housing 1010 to accommodate the folded module 1100 and the lens module 1200.

In an embodiment, a baffle 1040 configured to prevent flare may be disposed in the housing 1010. The baffle 1040 may have a frame including a through portion 1041 therein, and may be inserted into an internal structure of the housing 1010. The baffle 1040 may have a shape corresponding to the shape of an opening 1011 formed in the housing 1010. A portion of light reflected from the reflective member 1410 and directed to the image sensor 1310 may be absorbed by the baffle 1040 or may be diffusely reflected by the baffle 1040, which may prevent or inhibit flare.

Since a camera employed in an electronic device provides various functions (e.g., optical image stabilization and autofocusing,) and high performance, there may be a limitation in reducing the thickness of the camera module 1000. The thickness of the electronic device may be determined by the thickness of the camera module 1000.

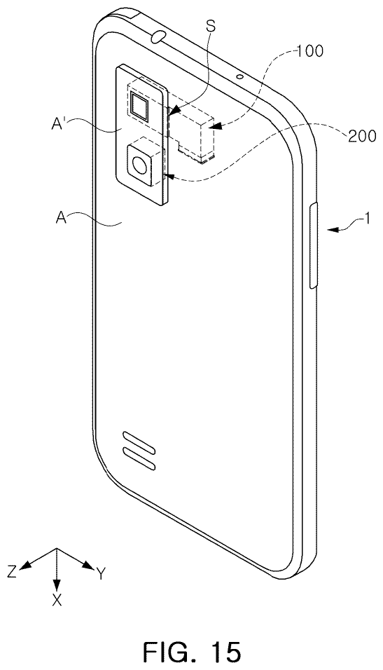

Referring to FIG. 15, a first camera module 100 (corresponding to the camera module 1000 in FIG. 1) may be provided on a rear surface A of an electronic device 1 together with a second camera module 200. Since the thickness of the second camera module 200 is large, a portion A′ protruding from the rear surface A of the electronic device 1 may be present due to the camera. The portion A′ may, however, impair usability and aesthetical appeal, and thus, it may be important to reduce the size of the protruding portion A′.

The first camera module 100 may include a step portion S similarly to the camera module 1000 in FIG. 1, which may contribute to reducing the size of the portion A′ protruding from the rear surface A of the electronic device 1 due to the camera.

In an embodiment, the camera module 1000 may include the step portion S having a reduced thickness in a middle region. For example, the step portion S may be disposed in the middle region of the camera module 1000 or approximately in the middle region of the camera module 1000. For example, the step portion S may be provided at a position ⅓ to ⅔ of a distance along the length of the camera module 1000 in the optical axis direction (e.g., a direction of a path of the light L reflected by the reflective module 1400). For example, the step portion S may have a surface perpendicular to a path of light between the lens module 1200 and the reflective module 1400 as a boundary. For example, the step portion S may be disposed on a path of light from a forwardmost lens on the object side of the lens module 1200 to the reflective module 1400.

Referring to FIG. 1, the cover 1030 may include a step portion S in the Y-axis direction, and the camera module 1000 may have a different height (or thickness) before and after the step portion S. For example, the height of the side of the camera module 1000 on which the opening 1031 for receiving light is disposed may be higher than that of the opposite side of the camera module 1000 by S1.

Referring to FIG. 4A together with FIG. 1, in an embodiment, both the lens module 1200 and the housing 1010 may have a step difference corresponding to the step portion S, which is exposed on an exterior of the camera module 1000.

In an example embodiment, the lens barrel 1210 and the lens holder 1220 may be distinct from each other, and each of the lens barrel 1210 and the lens holder 1220 may have at least one step difference (e.g., S2, S3, and S4). For example, the lens holder 1220 may include a second step difference S2, and the lens barrel 1210 may include a third step difference S3 and a fourth step difference S4.

For example, the second step difference S2 of the lens holder 1220 and the third step difference S3 of the lens barrel 1210 may be disposed in a position exposed on the exterior of the camera module 1000 and corresponding to the step portion S. The fourth step difference S4 of the lens barrel 1210 may be configured to be easily assembled the lens holder 1220 with the lens barrel 1210.

In an embodiment, the housing 1010 may include a fifth step difference S5 corresponding to the step difference of the step portion S. For example, the sidewall 1010b forming the housing 1010 may have a different height (a length in the Z-axis direction) based on the fifth step difference S5.

Referring back to FIG. 15, the first camera module 100 may be partially spaced apart from the second camera module 200 in the X-axis direction. The first camera module 100 may include a first portion overlapping the second camera module 200 in the X-axis direction and a second portion not overlapping the second camera module 200. Also, the step portion S of the first camera module 100 may be disposed between the first portion and the second portion. When the thicknesses of the first portion and the second portion are the same, a width (a length in the Y-axis direction) of the portion protruding from the rear surface of the electronic device may be greater than a width of the portion A′ illustrated in the drawing. Since the thickness of the second portion is less than the thickness of the first portion in the first camera module 100, the width of the portion A′ protruding by the first and second camera modules 100 and 200 may be less than the width of the first camera module 100.

FIG. 4B is a cross-sectional diagram taken along line I-I′ of FIG. 2, and illustrating the lens module 1200. FIG. 4C is a cross-sectional diagram along line II-II′ of FIG. 2, and illustrating the lens module 1200.

Referring to FIGS. 4B and 4C, the lens holder 1220 may be configured to accommodate the lens barrel 1210. For example, the lens holder 1220 may include a first support structure 1201 and a second support structure 1202 extending in the optical axis direction (Y-axis direction). The lens barrel 1210 may be accommodated in a space between the first support structure 1201 and the second support structure 1202.

In an embodiment, a portion of the lens barrel 1210 may further protrude from the lens holder 1220 toward the reflective member 1110. For example, the object-side (i.e., −Y direction) end 1210a of the lens barrel 1210 may be located closer to the object side than the object-side end 1220d of the lens holder 1220. A width (in the X direction) of the object side end 1210a of the lens barrel 1210 is smaller than the distance between a first stopper 1510 and a second stopper 1520 disposed in the housing 1010.

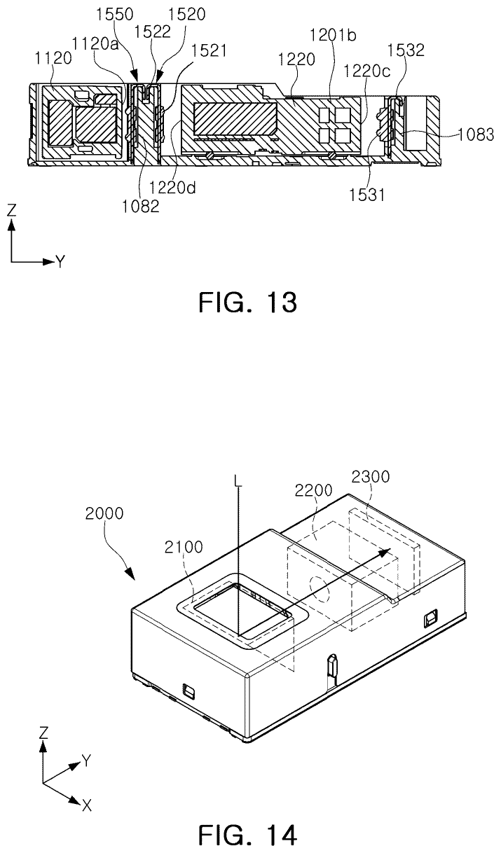

Accordingly, referring to FIG. 3 and FIG. 13 together, when the lens holder 1220 comes into contact with the first stopper 1510 and the second stopper 1520 attached to the housing 1010, a portion of lens barrel 1210 may be located in a space between the first stopper 1510 and the second stopper 1520. In this case, the optical path between the image sensor 1310 and the lens 1211 may be lengthened at a given size of the camera module 1000, and the magnification provided by the camera module 1000 may be increased.

For example, the first support structure 1201 and the second support structure 1202 may be disposed in opposite directions with respect to the optical axis. The first support structure 1201 and the second support structure 1202 may oppose each other with the optical axis interposed therebetween. For example, the first support structure 1201 and the second support structure 1202 be formed as plates extending in the optical axis direction and opposing each other in the X direction.

For example, an internal structure of the lens holder 1220 may have a shape corresponding to an external structure of the lens barrel 1210. For example, the lens barrel 1210 may include a curved surface, and portions of the first and second support structures 1201 and 1202 opposing the lens barrel 1210 may also include a curved surface corresponding to the curved surface of the lens barrel 1210. For example, the lens barrel 1210 may include a step portion in the optical axis direction, and the internal structure of the first and second support structures 1201 and 1202 may also include a step difference corresponding to a step difference of the lens barrel 1210 formed by the step portion of the lens barrel 1210.

In an embodiment, the first support structure 1201 may have a length greater than a length of the second support structure 1202 in the optical axis direction. For example, the first support structure 1201 may include a first portion 1201a opposing the second support structure 1202 in the X direction, and a second portion 1201b (or an extension portion) extending farther in the +Y direction from an end of the first portion 1201a. The first portion 1201a of the first support structure 1201 may have a length the same as or almost the same as the length of the second support structure 1202 in the optical axis direction. Due to the second portion 1201b of the first support structure 1201, the first support structure 1201 may protrude farther in the +Y direction than the second support structure 1202. Due to the second portion 1201b, the first supporting structure 1201 may protrude farther than the second supporting structure 1202 in the direction of the rear side (+Y direction) of the lens barrel 1210.

The second support structure 1202 may be configured to not interfere with light directed from the reflective module 1400 to the image sensor 1310.

The lens holder 1220 may include a structure connecting the first support structure 1201 to the second support structure 1202. For example, the lens holder 1220 may include an upper structure 1203 connecting an upper portion of the first support structure 1201 to an upper portion of the second support structure 1202. The lens holder 1220 may include a lower structure 1204 connecting a lower portion of the first support structure 1201 to a lower portion of the second support structure 1202.

The upper structure 1203 and the lower structure 1204 of the lens holder 1220 may be disposed above (+Z direction) and below (−Z direction) the lens barrel 1210, respectively. The thickness (length in the Z-axis direction) of the lens barrel 1210 may decrease toward the rear side (+Y direction), and due to the reduced thickness, the upper structure 1203 and the lower structure 1204 may be disposed in the space 1212 provided in upper and lower portions of the lens barrel 1210.

For example, in the lens barrel 1210, a thickness of the rear portion may be less than the thickness of the front portion with respect to the third step difference S3 or the fourth step difference S4 as a boundary, when viewed in the X-axis direction. A portion of the upper structure 1203 and the lower structure 1204 may be disposed in the space 1212 provided in the upper and lower portions of the lens barrel 1210 due to the reduced thickness of the lens barrel 1210. Accordingly, an increase in the thickness of the lens module 1200 caused by providing the lens barrel 1210 and the lens holder 1220 as separate components may be reduced.

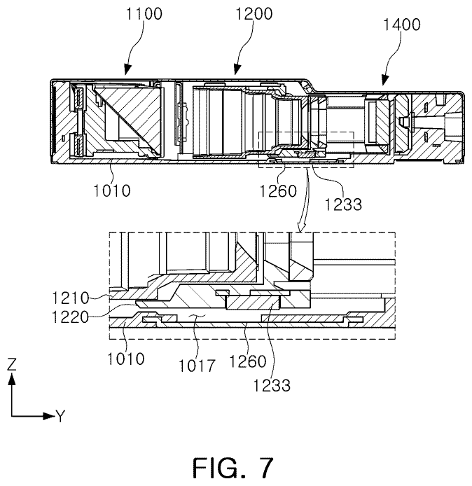

In an embodiment, the driving elements necessary for automatic focus adjustment may be disposed in the lens holder 1220. For example, a first magnet 1231 may be provided on the second support structure 1202. For example, a second magnet 1232 may be provided on the first support structure 1201. Referring to FIG. 7 together with FIGS. 4B and 4C, a first magnetic member 1233 may be disposed in the lower structure 1204. The first magnetic member 1233 may be disposed in a portion of the lower structure 1204 opposing a bottom surface 1010a of the housing 1010.

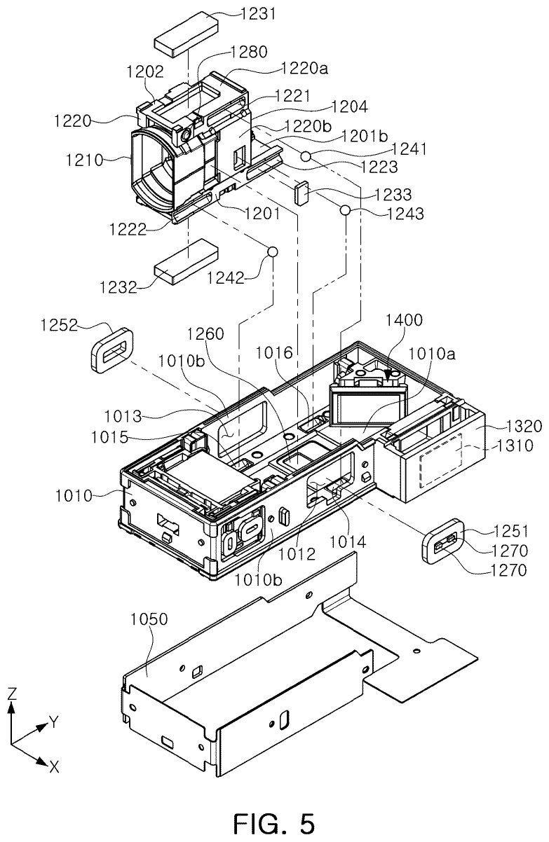

Referring to FIG. 5 together with FIGS. 4B and 4C, guide grooves 1221, 1222, and 1223 may be disposed on the bottom surfaces of the first and second support structures 1201 and 1202. The first support structure 1201 may include a second guide groove 1222 and a third guide groove 1223 on the bottom surface thereof. The second support structure 1202 may include a first guide groove 1221 on the bottom surface thereof.

At least a portion of the third guide groove 1223 may be provided in the extension portion 1201b, and a third ball member 1243 may slide or roll along the third guide groove 1223. The third ball member 1243 may support the extension portion 1201b and may function as one of several support points for supporting the lens module 1200.

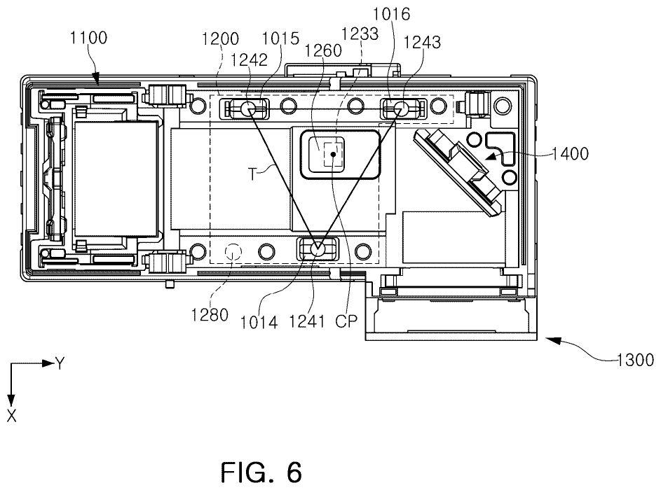

For the camera module 1000 to provide a high zoom magnification, the lens barrel 1210 may have a relatively long stroke. Thus, to stably support the lens barrel 1210, a distance between support points supporting the lens barrel 1210 may need to be relatively large. For example, the lens barrel 1210 may be supported by ball members 1241, 1242, and 1243 disposed between the lens barrel 1210 and the housing 1010, and the ball members 1241, 1242, and 1243 may need to be relatively large such that the lens module 1200 may move stably without shaking. The supporting of the lens module 1200 by the ball members 1241, 1242, and 1243 will be described later in greater detail with reference to FIG. 6.

In an embodiment, the lens module 1200 may be formed asymmetrically to increase the distance between the ball members 1241, 1242, and 1243. For example, when viewed in the Z-axis direction, the lens module 1200 may have an asymmetric structure with respect to the optical axis. Referring to FIG. 5, to increase the distance between the second ball member 1242 and the third ball member 1243, the first support structure 1201 may include the extension portion 1201b extending farther than the second support structure 1202 to the rear side of the lens barrel 1210.

As the length of the first support structure 1201 increases, the distance between the second ball member 1242 and the third ball member 1243 may increase, and a size of the region (e.g., the support region T in FIG. 6) surrounded by the ball members 1241, 1242, and 1243 may further increase, which may contribute to the movement of the lens module 1200 with a relatively long stroke.

When the lens module 1200 is formed asymmetrically, the lens barrel 1210 and the lens holder 1220 may be provided as separate components. Structures forming the lens module 1200 may be deformed depending on the environment in which the lens module 1200 is manufactured or used. Since the lens module 1200 is asymmetrically formed, the degree of deformation may be greater. It may be important for the lenses 1211 included in the lens module 1200 to be precisely arranged along the optical axis, but due to the deformation, the arrangement of the lenses 1211 may be misaligned, which may result in deterioration of image quality.

The lens barrel 1210 may have a symmetrical structure with respect to the optical axis, and the lens holder 1220 may be formed separately from the lens barrel 1210 and may have an asymmetrical structure with respect to the optical axis.

For example, the lens barrel 1210 may be configured symmetrically with reference to a surface including an optical axis and perpendicular to the direction (the X-axis direction) in which the first support structure 1201 and the second support structure 1202 oppose each other. For example, referring to FIG. 4B, the lens barrel 1210 may have a symmetrical shape with respect to a surface parallel to the YZ plane and including the optical axis. The lens barrel 1210 may be configured symmetrically with respect to a surface including the optical axis and parallel to the direction in which the first support structure 1201 and the second support structure 1202 oppose each other. For example, referring to FIG. 4C, the lens barrel 1210 may have a symmetrical shape with respect to a surface parallel to the XY plane and including the optical axis.

Referring to FIG. 4B, the light L incident to the first reflective member 1110 in a first direction (e.g., −Z direction) may be reflected toward the optical axis. The lens barrel 1210 may be configured to be symmetrical with respect to a first surface including an optical axis and parallel to the first direction. For example, the lens barrel 1210 may have a symmetrical shape with respect to a surface parallel to the YZ plane and including the optical axis. Referring to FIG. 4B, the first support structure 1201 disposed in the −X direction with respect to the optical axis may have a structure different from that of the second support structure 1202 disposed in the +X direction, and accordingly, the lens holder 1220 may be configured asymmetrically with respect to the first surface, differently from the lens barrel 1210.

Referring to FIG. 4C, the lens barrel 1210 may be configured to have a symmetrical shape with respect to a surface including the optical axis and perpendicular to the first direction. In an embodiment, the lens barrel 1210 may be configured to have a symmetrical shape with respect to a surface including the optical axis and perpendicular to a reflective surface 1110a of the first reflective member 1110. For example, referring to FIG. 4C, the lens barrel 1210 may have a symmetrical shape with respect to a surface parallel to the XY plane and including the optical axis.

In an embodiment, even when the lens module 1200 has an asymmetric structure to have a long stroke, the lens barrel 1210 may have a symmetrical structure, and accordingly, misalignment of the lenses 1211 may be prevented or may be reduced.

FIG. 5 is an exploded perspective diagram illustrating a driver of the lens module 1200, according to an embodiment. FIG. 6 is a diagram illustrating a positional relationship between a support point of the lens module 1200 and the first magnetic member 1233 in a camera module 1000, as viewed from the above, according to an embodiment. FIG. 7 is a cross-sectional diagram illustrating the camera module 1000 taken along line III-III′ of FIG. 3. More specifically, FIG. 7 illustrates a cross-sectional surface of the camera module 1000 such that the first magnetic member 1233 disposed in the lens module 1200 and a second magnetic member 1260 provided in the housing 1010 are shown.

The lens module 1200 may be configured to move in the housing 1010. For example, as the lens module 1200 moves back and forth in one direction with respect to the housing 1010, a focus or magnification of an image formed on the image sensor 1310 may be adjusted. For example, the lens module 1200 may move in a direction parallel to the optical axis (Y axis) with respect to the housing 1010.

The lens module may include guide grooves configured to guide the ball members 1241, 1242, and 1243 in a direction parallel to the optical axis, respectively. The ball members 1241, 1242, and 1243, the guide grooves 1221, 1222, 1223 described above, and guide grooves 1014, 1015, and 1016 may be used to guide the movement of the lens module 1200. The lens module 1200 and the housing 1010 may include the guide grooves 1221, 1222, 1223, 1014, 1015, and 1016 (referred to hereinafter as first, second, third, fourth, fifth, and sixth guide grooves, respectively) extending in the optical axis (Y-axis direction) in portions opposing each other, respectively. The ball members 1241, 1242, and 1243 (referred to hereinafter as first, second, and third ball members, respectively) may be disposed between the guide grooves 1221, 1222, 1223 formed in the lens module 1200 and the guide grooves 1014, 1015, and 1016 formed in the housing 1010.

In an embodiment, since the ball members 1241, 1242, and 1243 move only in the direction in which the guide grooves 1221, 1222, 1223, 1014, 1015, and 1016 extend, the movement direction of the lens module 1200 may be limited in the length direction (Y-axis direction) of the guide grooves 1221, 1222, 1223, 1014, 1015, and 1016 with respect to the housing 1010.

For example, the lens holder 1220 may include the first guide groove 1221, the second guide groove 1222, and the third guide groove 1223 on a lower surface 1220b of the lens holder 1220. The housing 1010 may include a fourth guide groove 1014, a fifth guide groove 1015, and a sixth guide groove 1016 corresponding to the first guide groove 1221, the second guide groove 1222, and the third guide groove 1223, respectively, on the bottom surface 1010a. The first ball member 1241 may be disposed between the first guide groove 1221 and the fourth guide groove 1014, the second ball member 1242 may be disposed between the second guide groove 1222 and the fifth guide groove 1015, and the third ball member 1243 may be disposed between the third guide groove 1223 and the sixth guide groove 1016.

In an embodiment, the camera module 1000 may include a driver for providing a driving force to the lens module 1200. The driver may include, for example, the first and second magnets 1231 and 1232 disposed in the lens module 1200, and first and second coils 1251 and 1252 disposed in the housing 1010.

The first magnet 1231 and the second magnet 1232 may be provided on a side surface 1220a of the lens holder 1220. The first coil 1251 and the second coil 1252 may correspond to the first magnet 1231 and the second magnet 1232, respectively. The lens module 1200 may move back and forth in one direction with respect to the housing 1010 through electromagnetic interaction between the first and second coils 1251 and 1252 and the first and second magnets 1231 and 1232, respectively. For example, a Lorentz force generated in the first and second coils 1251 and 1252 and the first and second magnets 1231 and 1232 may move the lens module 1200 in one direction with respect to the housing 1010.

In an embodiment, the first coil 1251 and the second coil 1252 may be attached to a substrate 1050 disposed on an external wall of the housing 1010. The first coil 1251 and the second coil 1252 may interact with the first magnet 1231 and the second magnet 1232 through openings 1012 and 1013 disposed in the housing 1010, respectively. The openings 1012 and 1013 may have sizes corresponding to sizes of the first coil 1251 and the second coil 1252, respectively.

The lens holder 1220 may need to move while being in close contact with the housing 1010. In other words, while the lens holder 1220 moves with respect to the housing 1010, the ball members 1241, 1242, and 1243 may need to maintain a contact state with the guide grooves 1221, 1222, 1223, 1014, 1015, and 1016 provided on both sides. Referring to FIG. 5, the first ball member 1241 may need to maintain a contact state with the first guide groove 1221 and the fourth guide groove 1014, the second ball member 1242 may need to maintain a contact state with the second guide groove 1222 and the fifth guide groove 1015, and the third ball member 1243 may need to maintain a contact state with the third guide groove 1223 and the sixth guide groove 1016. When one of the first ball member 1241, the second ball member 1242, and the third ball member 1243 is released from being in contact with the respective guide grooves 1221, 1222, 1223, 1014, 1015, and 1016, the movement direction of the lens holder 1220 may be no longer limited to one direction. For example, the lens holder 1220 may need to move only move in the Y-axis direction, and when the contact state between the ball members 1241, 1242, and 1243 and the guide grooves 1221, 1222, 1223, 1014, 1015, and 1016 is released, the lens holder 1220 may also be shaken in the Z-axis or X-axis direction, which may result in deterioration of an autofocus function and image quality.

Accordingly, each of the housing 1010 and the lens holder 1220 may include an element for pulling each other. For example, the lens holder 1220 and the housing 1010 may include the first magnetic member 1233 and the second magnetic member 1260, respectively, in portions opposing each other. One or more first magnetic members 1233 and one or more second magnetic members 160 may be provided.

In an embodiment, the camera module may include a first magnetic member provided in the lens module, and a second magnetic member provided in the housing to oppose the first magnetic member, and lens module may be attached to one surface of the housing by magnetic attraction force generated between the first magnetic member and the second magnetic member.

A combination of the first and second magnetic members 1233 and 1260 disposed in the lens holder 1220 and the housing 1010 may be configured to generate magnetic attraction force therebetween. For example, the second magnetic member 1260 may be a magnet, and the first magnetic member 1233 may be a magnet or a yoke. In another example, the second magnetic member 1260 may be a yoke, and the first magnetic member 1233 may be a magnet.

Referring to FIG. 5, the first magnetic member 1233 may be disposed on a lower surface 1220b of the lens holder 1220, and the second magnetic member 1260 may be provided on the bottom surface 1010a of the housing 1010. The lens holder 1220 may include a recessed portion configured to accommodate the first magnetic member 1233.

Referring to FIG. 7, the second magnetic member 1260 may be disposed externally of the housing 1010, and the housing 1010 may include an opening 1017 through which a portion of the second magnetic member 1260 is exposed into the housing 1010. A portion of the housing 1010 may be disposed between the first magnetic member 1233 and the second magnetic member 1260 according to the driving of the lens module 1200, and the magnetic attraction force between the first magnetic member 1233 and the second magnetic member 1260 may still draw the lens module 1200 to the bottom surface 1010a of the housing 1010.

A force drawing the lens holder 1220 to the bottom surface 1010a of the housing 1010 may continuously act on the lens holder 1220 due to the first and second magnetic members 1233 and 1260, and accordingly, the lens holder 1220 may move while being in close contact with the bottom surface 1010a of the housing 1010. Thus, the magnetic attraction force by the first and second magnetic members 1233 and 1260 may allow the ball members 1241, 1242, and 1243 to be in contact with the guide grooves 1221, 1222, 1223, 1014, 1015, and 1016 disposed on both sides of the ball members 1241, 1242, and 1243.

In an embodiment, the lens holder 1220 may be formed asymmetrically. Referring to FIGS. 4A and 5, the lens holder 1220 may include the extension portion 1201b extending in the optical axis direction. The lens holder 1220 may include the two support structures (or sidewalls) 1201 and 1202 surrounding the lens barrel 1210 from both sides with respect to the optical axis. The length of the support structure 1201 on one side in the optical axis direction may be configured to be longer than the length of the support structure 1202 on the other side thereof in the optical axis direction. In this case, a portion of the support structure 1201 on one side of the optical axis, which may extend further than the length of the support structure 1202 on the other side in the optical axis direction may be defined as the extension portion 1201b.

In an embodiment, the lens holder 1220 may have at least three or more support points and may be in close contact with the bottom surface 1010a of the housing 1010. In an embodiment, at least one support point may be present in the extension portion 1201b of the lens holder 1220. For example, at least a portion of the third guide groove 1223 may be disposed in the extension portion 1201b, and the third ball member 1243, which is partially accommodated in the third guide groove 1223, may provide a single support point.

A single support point does not refer to a single point physically, and may include two or more contact points disposed adjacent to each other. For example, when the third guide groove 1223 has a V-shaped cross-sectional surface, the third ball member 1243 may have two contact points with the third guide groove 1223, and the two contact points may be included in a single support point. For another example, when the third guide groove 1223 has a wide bottom surface, the third ball member 1243 may have a single contact point with the bottom surface of the third guide groove 1223, and the single contact point may form a single support point.

Referring to FIG. 6, the second magnetic member 1260 may be configured to cover overall movement sections of the first magnetic member 1233. For example, length of the second magnetic member 1260 in the Y-axis direction may correspond to the movement section of the first magnetic member 1233. Even when the first magnetic member 1233 moves according to the driving of the lens module 1200, the first magnetic member 1233 may be always disposed on the second magnetic member 1260, and magnetic attraction force may be generated between the first magnetic member 1233 and the second magnetic member 1260.

Referring to FIG. 6, when the lens module 1200 moves on the housing 1010, the position of the first magnetic member 1233 may be disposed in a triangular support region T defined by the ball members 1241, 1242, and 1243. In an embodiment, the second magnetic member 1260 may also be disposed in the triangular support region T defined by the ball members 1241, 1242, and 1243.

The first magnetic member 1233 may be disposed in the support region T defined by the ball members 1241, 1242, and 1243 such that the lens module 1200 may be stably driven. For example, if the distance between the second ball member 1242 and the third ball member 1243 were to be narrower than the example illustrated in the drawing, the first magnetic member 1233 may be disposed at an edge of the support region T or a position beyond the support region T when the first magnetic member 1233 moves in the Y-axis direction. In this case, the lens module 1200 may be inclined by the magnetic attraction force between the first magnetic member 1233 and the second magnetic member 1260, and the contact between the ball members 1241, 1242, and 1243 and the guide grooves 1221, 1222, 1223, 1014, 1015, and 1016 may be released. Also, since the driving length of the lens module 1200 in the camera module 1000 providing a high zoom magnification is relatively large, it may be highly likely that the above-described issue may occur if the support region T is narrow.

In an embodiment, the lens module 1200 may be supported at three points by the three ball members 1241, 1242, and 1243 disposed between the lens module 1200 and the housing 1010. Also, the first magnetic member 1233 may be disposed in the lens module 1200 to be disposed in a triangle (a virtual triangle) support region T connecting the ball members 1241, 1242, and 1243 to each other while the lens module 1200 moves. The triangle support region T is formed by virtual lines connecting the ball members 1241, 1242, and 1243 to each other. In the disclosed embodiment, the configuration in which the first magnetic member 1233 is disposed in the triangle support region T may include the configuration in which a portion of the first magnetic member 1233 is disposed in the triangle support region T, and may not be limited to the example in which the first magnetic member is entirely disposed in the triangle support region T.

In an embodiment, the first magnetic member 1233 may be disposed such that a center of the magnetic attraction force is disposed in the triangle support region T connecting the support points while the lens module 1200 moves in the optical-axis direction, when viewed in the Z-axis direction. The center of the magnetic attraction force may approximately coincide with a geometric center CP of the first magnetic member 1233. Accordingly, as for the center CP of the first magnetic member 1233, the center of magnetic attraction force may be disposed in the triangle support region T connecting the support points while the lens module 1200 moves in the optical axis direction.

Referring to FIGS. 4A to 4C, in an embodiment, the lens module 1200 may include the first support structure 1201 extending in the optical axis direction and the second support structure 1202 disposed on the opposite side of the first support structure 1201 and extending in the optical axis direction. In this case, the second and third ball members 1242 and 1243 of the ball members 1241, 1242, and 1243 may be disposed between the first support structure 1201 and the housing 1010, and the first ball member 1241 may be disposed between the second support structure 1202 and the housing 1010.

In an embodiment, the first support structure 1201 may include the extension portion 1201b protruding further than the second support structure 1202 in the optical axis direction, and one of the second and third ball members 1242 and 1243 disposed between the first support structure 1201 and the housing 1010 may be disposed between the extension portion 1201b and the housing 1010.

In an embodiment, the first magnetic member 1233 may be disposed more adjacent to the first support structure 1201 than the second support structure 1202. Since two of the three points supporting the lens module 1200 are disposed on the first support structure 1201, the first magnetic member 1233 may be disposed adjacent to the first support structure 1201 for the lens module 1200 to stably move in the optical axis direction.

In an embodiment, the lens module 1200 may include the extension portion 1201b, and a portion of the extension portion 1201b may define the third guide groove 1223. Since the third ball member 1243 is disposed in the third guide groove 1223 formed in the extension portion 1201b, the distance between the second ball member 1242 and the third ball member 1243 may be relatively great. When the distance between the second ball member 1242 and the third ball member 1243 increases, the size of the support region T defined by the ball members 1241, 1242, and 1243 may increase, which may indicate that the range in which the first magnetic member 1233 may move may increase.

Accordingly, the lens module 1200, having a relatively long driving length, may also be stably supported by the housing 1010. Also, even when the driving distance of the lens module 1200 increases to provide a high zoom magnification, the lens module 1200 may be stably driven according to the embodiments described herein.

In an embodiment, the first magnetic member 1233 may be disposed on the lower surface 1220b of the lens holder 1220, and may be disposed more adjacent to the first support structure 1201 than the second support structure 1202. For example, the first magnetic member 1233 may be disposed more adjacent to the second guide groove 1222 (or the third guide groove 1223) than the first guide groove 1221. The lens holder 1220 may be supported by the three ball members 1241, 1242, and 1243, and the second and third ball members 1242 and 1243 of the three ball members 1241, 1242, and 1243 may be disposed in the second and third guide grooves 1222 and 1223 formed in the first support structure 1201.

The first magnetic member 1233 may be disposed more adjacent to the first support structure 1201 such that the lens holder 1220 may be stably supported. That is because, referring to FIG. 6, the first magnetic member 1233 may move along the optical axis (Y-axis) and, when the first magnetic member 1233 is disposed on the side defined by the second ball member 1242 and the third ball member 1243, the range in which the first magnetic member 1233 moves in the support region T defined by the ball members 1241, 1242, and 1243 may be widened.

As the lens module 1200 moves with respect to the housing 1010, the ball members 1241, 1242, and 1243 may also roll in the same direction, which means that the support region T may also move along the housing 1010. However, the rolling distance of the ball members 1241, 1242, and 1243 may simply coincide with the moving distance of the lens module 1200, and the moving distance of the centers of the ball members 1241, 1242, and 1243 may be less than the moving distance of the lens module 1200, and thus, it may be important for the ball members 1241, 1242, and 1243 to provide the support region T of a relatively large area. Therefore, the extension portion 1201band the third ball member 1243, which is disposed in the extension portion 1201b, may contribute to stably supporting the lens module 1200.

In an embodiment, one of the support points may be disposed on the extension portion 1201b, and the support point disposed on the extension portion 1201b may not be necessarily provided by a combination of the ball member and the guide groove (e.g., the first ball member 1241, the first guide groove 1221, and the fourth guide groove 1014). For example, the extension portion 1201b may include a portion protruding to the bottom surface 1010a of the housing 1010, and one of the support points of the lens module 1200 may be provided by the protruding portion. In another example, the protruding portion may extend from the bottom surface 1010a of the housing 1010 toward the extension portion 1201b, and may form a support point for the lens module 1200.

In an embodiment, in addition to the three ball members 1241, 1242, and 1243, other structures may support a portion of the lens module 1200. For example, the lens holder 1220 may include a protrusion 1280 protruding to the bottom surface 1010a of the housing 1010 on the lower surface of the second support structure 1202. The protrusion 1280 may be configured to support the lens module 1200 in an auxiliary manner. When the lens module 1200 is assembled to the housing 1010, an air gap may be present between the end of the protrusion 1280 and the bottom surface 1010a of the housing 1010. When a strong impact is applied to the lens module 1200, the protrusion 1280 may support the lens module 1200 together with the ball members 1241, 1242, and 1243. In another embodiment, the protrusion 1280 may be replaced with guide grooves provided in the ball member, the housing 1010, and the lens holder 1220, respectively.

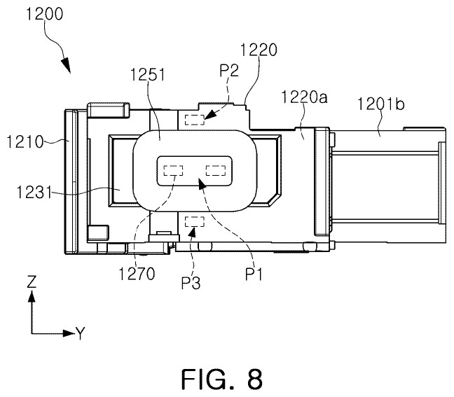

FIG. 8 is a diagram illustrating the lens module 1200, according to an embodiment.

In an embodiment, since the magnification or focus of an image reaching the image sensor may vary depending on the position of the lens module 1200, the position of the lens module 1200 may need to be measured. Accordingly, the camera module 1000 may include at least one position sensor 1270 configured to measure the position of the lens module 1200.

In an embodiment, the position sensor 1270 may be fixed to the housing 1010, and may be configured to sense changes of the position of the first magnet 1231 according to rotation of the lens module 1200 with respect to the housing 1010.

In an embodiment, the position sensor 1270 may be disposed in an internal portion P1 the first coil 1251. For example, a hall sensor using a hall effect may generate a signal indicating the position of the magnet from the position sensor 1270 by sensing a magnetic field of the magnet. Accordingly, the position sensor 1270 may be disposed in a portion opposing the first magnet 1231, and may thus be disposed in an internal portion P1 of the first coil 1251.

To accurately measure the position of the lens module 1200, which is configured to move a relatively long distance, two or more position sensors 1270 may be disposed in an internal portion P1 of the first coil 1251.

In another embodiment, the position sensor 1270 may be disposed on the external portions P2 and P3 of the first coil 1251. For example, the position sensor 1270 may be disposed in an upper portion P2 or a lower portion P3 of the first coil 1251. In this case, the position sensor 1270 may not oppose the first magnet 1231. For example, when the first magnet 1231 is disposed on a first portion of the side surface 1220a of the lens holder 1220, the position sensor 1270 may be disposed to oppose a second portion of the side surface 1220a of the lens holder 1220, distinct from the first portion.

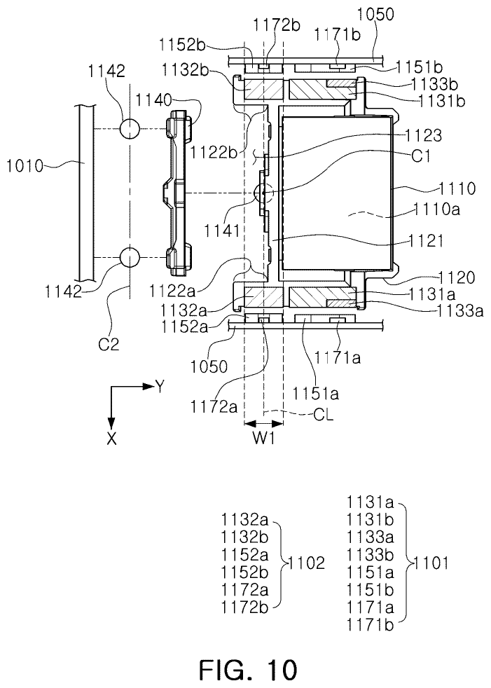

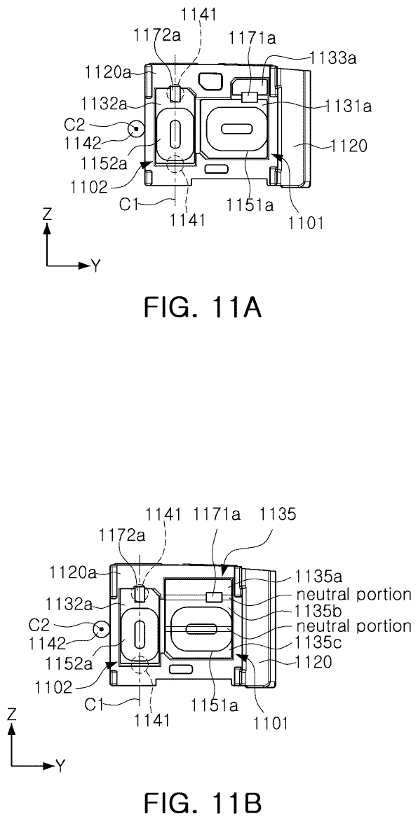

FIG. 9 is an exploded perspective diagram illustrating the folded module 1100, according to an embodiment. FIG. 10 is a diagram illustrating the folded module 1100, according to an embodiment. FIGS. 11A and 11B are diagrams illustrating the folded module 1100, according to some embodiments.

Referring to FIG. 9, the folded module 1100 may include the reflective member 1110 and a rotational holder 1120 accommodating the reflective member 1110.

The folded module 1100 may be configured to rotate in the housing 1010. For example, the folded module 1100 may rotate in a direction perpendicular to the optical axis (Y axis). For example, the folded module 1100 may rotate in a Z-axis and/or an X-axis direction. As the folded module 1100 rotates in a direction perpendicular to the optical axis, an optical image stabilization function may be implemented.

In an example embodiment, the folded module 1100 may be attached to a sidewall 1010c extending vertically (for example, in the Z-axis direction) from the bottom of the housing 1010. In an example embodiment, the folded module 1100 and the sidewall 1010c of the housing 1010 may include third and fourth magnetic members 1134 and 1160, respectively, in portions opposing each other. The third and fourth magnetic members 1134 and 1160 may be configured to generate magnetic attraction force acting therebetween.

For example, the fourth magnetic member 1160 may be disposed in the housing 1010 and may be a magnet, and the third magnetic member 1134 may be disposed in the folded module 1100 and may be a magnet or a yoke. In another example, the fourth magnetic member 1160 may be a yoke, and the third magnetic member 1134 may be a magnet.

In an embodiment, the rotational holder 1120 may include a recess 1122 configured to accommodate a magnet. In an embodiment, a portion 1160a of the fourth magnetic member 1160 may be disposed on the sidewall 1010c of the housing 1010 to oppose the third magnetic member 1134 of the folded module 1100. Accordingly, the folded module 1100 may be attached to the sidewall 1010c of the housing 1010.

In an embodiment, the folded module 1100 may include a rotating plate (or a middle guide) 1140 configured to guide the rotation of the folded module 1100. The rotating plate 1140 may be disposed between the rotational holder 1120 and the housing 1010, and may guide the rotational holder 1120 to rotate about the X axis or the Z axis with respect to the housing 1010.

A first ball group 1141 including ball members may be disposed between the rotational holder 1120 and the rotating plate 1140. For example, the rotational holder 1120 and the rotating plate 1140 may include grooves 1121 and 1143, respectively, configured to accommodate at least a portion of the first ball group 1141. The ball members included in the first ball group 1141 may be arranged along a line in the Z-axis direction, and may define a rotation axis (or pitch axis) parallel to the Z-axis. The rotational holder 1120 may rotate about a rotation axis defined by the first ball group 1141 with respect to the rotating plate 1140 (or the rotating plate 1140 may rotate with respect to the rotational holder 1120).

A second ball group 1142 including ball members may be disposed between the rotating plate 1140 and the housing 1010. For example, the rotating plate 1140 may include a groove 1144 configured to accommodate at least a portion of the second ball group 1142. The ball members forming the second ball group 1142 may be arranged in the X-axis direction, and may define a rotation axis parallel to the X-axis. The rotating plate 1140 may rotate with respect to the housing 1010 about a rotation axis defined by the second ball group 1142. Since the rotational holder 1120 rotates about the Z axis with respect to the rotating plate 1140, the rotational holder 1120 may rotate about the X axis and the Z axis with respect to the housing 1010.

In an embodiment, the camera module 1000 may include a driver configured to provide a driving force (or moment) to the folded module 1100. For example, the driver may include magnets 1131a, 1131b, 1132a, and 1132b (hereinafter referred to as first, third, second, and fourth magnets, respectively) disposed in the folded module 1100 and coils 1151a, 1151b, 1152a, and 1152b (hereinafter referred to as first, third, second, and fourth coils, respectively) disposed in the housing 1010. The rotational force driving the folded module 1100 may be provided by interaction between the magnets 1131a, 1131b, 1132a, and 1132b disposed in the folded module 1100 and the coils 1151a, 1151b, 1152a, and 1152b disposed in the housing 1010.

Referring to FIGS. 10 and 11, the first magnet 1131a and the second magnet 1132a may be provided on one side surface (e.g., a surface directed to the +X direction) of the rotational holder 1120. The first coil 1151a and the second coil 1152a opposing the first magnet 1131a and the second magnet 1132a, respectively, may be disposed on the housing 1010 side.

For example, the first coil 1151a and the second coil 1152a may be attached to the substrate 1050 disposed on an external wall of the housing 1010. The first coil 1151a and the second coil 1152a may interact with the first magnet 1131a and the second magnet 1132a, respectively, through an opening 1018 disposed in the housing 1010. The opening 1018 may have a size corresponding to a size of the first coil 1151a and the second coil 1152a.

For example, the third magnet 1131b and the fourth magnet 1132b may be disposed on the other side (e.g., the surface directed to the −X direction) of the rotational holder 1120. The third coil 1151b and the fourth coil 1152b opposing the third magnet 1131b and the fourth magnet 1132b, respectively, may be disposed on the housing 1010 side. In an embodiment, the third coil 1151b and the fourth coil 1152b may be attached to the substrate 1050. The third coil 1151b and the fourth coil 1152b may interact with the third magnet 1131b and the fourth magnet 1132b, respectively, through an opening 1019 disposed in the housing 1010. The opening 1019 may be configured to have a size corresponding to a size of the third coil 1151b and the fourth coil 1152b.

In an embodiment, the driver for preventing hand-shake, provided on one side of the folded module 1100, may include two sub-drivers divided depending on the rotation directions which the drivers relate to. For example, the first sub-driver 1101 may be configured to drive the X-axis rotation of the folded module 1100, and the second sub-driver 1102 may be configured to drive the Z-axis rotation of the folded module 1100.

For example, the first sub-driver 1101 may provide a moment in the X-axis direction to the rotational holder 1120 through the interaction between the first magnet 1131a and the first coil 1151a. The second sub driver 1102 may provide a moment in the Z-axis direction to the rotational holder 1120 through the interaction between the second magnet 1132a and the second coil 1152a.

For example, the first sub-driver 1101 may further include the third magnet 1131b and the third coil 1151b disposed symmetrically to the first magnet 1131a and the first coil 1151a with respect to the optical axis. For example, the second sub-driver 1102 may further include the fourth magnet 1132b and the fourth coil 1152b disposed symmetrically to the second magnet 1132a and the second coil 1152a with respect to the optical axis.

The first sub-driver 1101 includes driving elements for rotating the rotating holder 1120 about X-axis. The first sub-driver 1101 may include a first magnet 1131a, a third magnet 1131b, a first coil 1151a, and a third coil 1151b. The first sub-driver 1101 may further include position sensors 1171a and 1171b configured to detect rotation amount of the rotation holder 1120 about X-axis and magnets 1133a and 1133b for position sensing.

The second sub-driver 1102 includes driving elements for rotating the rotating holder 1120 about Z-axis. The second sub-driver 1102 may include a second magnet 1132a, a fourth magnet 1132b, a second coil 1152a, and a fourth coil 1152b. The second sub-driver 1102 may further include position sensors 1172a and 1172b configured to detect rotation amount of the rotation holder 1120 about Z-axis.

In the description below, the positional relationship between the driving elements 1131a, 1132a, 1151a, 1152a, 1171a, 1172a, and 1133a disposed on one side of the folded module 1100 with the rotational holder 1120 (or the housing 1010) will be described, and this description may also be applied to the driving elements 1131b, 1132b, 1151b, 1152b, 1171b, 1172b, and 1133b disposed on the other side of the folded module 1100.

In an embodiment, the first sub-driver 1101 and the second sub-driver 1102 may be disposed between portions opposing each other in the folded module 1100 and the housing 1010 (or the substrate 1050). For example, the first sub-driver 1101 and the second sub-driver 1102 may be provided between the first surface of the rotational holder 1120 and the second surface of the housing 1010 (or the substrate 1050), and the first surface and the second surfaces may oppose each other.

In the illustrated embodiment, the first sub-driver 1101 is disposed at the right side (+Y direction) of the second sub-driver 1102, but this is only an example, and in another embodiment, the first sub-driver 1101 may be disposed at the left side(−Y dir.) of the second sub-driver 1102. For example, the first magnet 1131a may be disposed on the left side (−Y dir.) of the second magnet 1132a.

In an embodiment, the first magnet 1131a and the second magnet 1132a may be disposed together on the first surface of the rotational holder 1120, and the first coil 1151a and the second coil 1152a may be disposed together on the second surface opposing the first surface of the rotational holder 1120 in the substrate 1050. For example, the first surface on which the first magnet 1131a and the second magnet 1132a are disposed or the second surface on which the first coil 1151a and the second coil 1152a are disposed may be perpendicular to, or approximately perpendicular to, the reflective surface 1110a of the folded module 1100.

The description of elements being disposed together on one surface may indicate that the elements may be disposed on surfaces directed to the same direction, and the magnets 1131a and 1132a or the coils 1151a and 1152a may not be necessarily disposed on the same plane. For example, the first magnet 1131a and the second magnet 1132a may be arranged in the rotational holder 1120 to be directed to the +X direction.

If a magnet were to be disposed on the lower surface (or bottom surface) of the folded module 1100, the thickness of the folded module 1100 and the thickness of the camera module 1000 may increase, such that it may be difficult to reduce the thickness of the camera module 1000. Also, in an electronic device including the camera module 1000, a magnetic member disposed below the camera module 1000 may adversely affect an optical image stabilization function. This is because the magnetic member may affect the magnetic field between the driving elements (the coil, the magnet, and the position sensor) for preventing hand-shake. Also, when a display including a digitizer is disposed below the camera module 1000, there may be an issue. For example, as a magnet affects the magnetic field of the digitizer, distortion may occur in an input of a stylus pen.

According to an embodiment, since the magnets 1131a, 1132a, 1151a, and 1152a, which are used as driving elements, are disposed on the side surface instead of the lower portion of the folded module 1100, the above-mentioned issues may be prevented or inhibited. In other words, by arranging the magnets 1131a, 1132a, 1151a, and 1152a, which are used as driving elements, necessary for preventing hand-shake on the side surface of the folded module 1100, the camera module 1000 having a reduced thickness may be implemented, and/or interference with the other electronic components may be prevented and inhibited.

In an example embodiment, the folded module 1100 may include position sensors 1171a, 1171b, 1172a, and 1172b (e.g., first, third, second, and fourth position sensors, respectively) configured to detect the amount of rotation of the folded module 1100. The position sensors 1171a, 1171b, 1172a, and 1172b may be fixed to the housing 1010, and may be configured to sense changes of the positions of the magnets 1131a, 1131b, 1132a, and 1132b disposed in the folded module 1100 according to the rotation of the folded module 1100 with respect to the housing 1010.

Hereinafter, the positional relationship between the first magnet 1131a, a fifth magnet 1133a, and the first position sensor 1171a provided on one side of the folded module 1100 will be described, and the description may also be applied to the relationship between the third magnet 1131b, a sixth magnet 1133b, and the third position sensor 1171b provided on the other side of the folded module 1100.

In an embodiment, the folded module 1100 may further include the fifth magnet 1133a for sensing a position on the surface on which the first and second driving magnets (the first and second magnets 1131a and 1132a) are disposed. For example, the first position sensor 1171a may be disposed in the housing 1010 (or the substrate 1050) so as to be disposed between the first magnet 1131a and the fifth magnet 1133a when the folded module 1100 is in a neutral state.

Referring to FIG. 10, the folded module 1100 may rotate about a pitch axis (or rotation axis) defined by the second ball group 1142 arranged in the X-axis direction. The pitch axis may be an axis parallel to the length direction (X-axis direction) of the reflective member 1110.

In an embodiment, the fifth magnet 1133a may be used to detect a pitch of the folded module 1100. In other words, the fifth magnet 1133a may be used to detect an amount by which the folded module 1100 rotates with respect to the pitch axis.

In an embodiment, the fifth magnet 1133a may be spaced apart from the first magnet 1131a in the circumferential direction with respect to the pitch axis. For example, the first magnet 1131a may be spaced apart from the pitch axis in the Y-axis direction, and the fifth magnet 1133a may be spaced apart from the first magnet 1131a in the circumferential direction (the Z-axis direction) with respect to the pitch axis.

In an embodiment, the first position sensor 1171a may be disposed in the housing 1010 (or the substrate 1050) to oppose the boundary between the fifth magnet 1133a and the first magnet 1131a.

For example, when the folded module 1100 rotates in a clockwise direction with respect to the pitch axis, the first position sensor 1171a may be spaced apart from the first magnet 1131a and may become adjacent to the fifth magnet 1133a. Conversely, when the folded module 1100 rotates in a counterclockwise direction with respect to the pitch axis, the first position sensor 1171a may become adjacent to the first magnet 1131a and may be spaced apart from the fifth magnet 1133a.

In an embodiment, a polarity of a portion of the first magnet 1131a adjacent to the fifth magnet 1133a may be different from a polarity of the fifth magnet 1133a. For example, referring to FIG. 11A, when the fifth magnet 1133a is disposed adjacent to an upper portion of the first magnet 1131a and the upper portion of the first magnet 1131a has an N pole (or an S pole), the fifth magnet 1133a may have an S pole (or an N pole). The polarity of the magnet may be the polarity of the surface of the magnet opposing the coil or the position sensor (the magnet surface illustrated in FIG. 11A).

In an embodiment, the first magnet 1131a and the fifth magnet 1133a may be integrated with each other. In this case, the integrated first and fifth magnets 1131a and 1133a may have different polarities based on a boundary on which a portion corresponding to the fifth magnet 1133a is in contact with a portion corresponding to the first magnet 1131a.

In the drawings of the disclosure, the fifth magnet 1133a is located on the upper side (+Z direction) of the first magnet 1131a, but this is only an example. In another embodiment, the fifth magnet 1133a may be located below the first magnet 1131a (−Z direction).

Referring to FIG. 11B, a single magnet 1135 is attached to the rotating holder 1120, and one surface of the magnet 1135 may include a first portion 1135a, a second portion 1135b, and a third portion 1135c, sequentially arranged in the vertical direction (i.e., the Z direction). Neutral portions may exist between the first portion 1135a, the second portion 1135b, and the third portion 1135b. For example, the first portion 1135a may have an N pole, the second portion 1135b may have an S pole, and the third portion 1135c may have an N pole. The first position sensor 1171a may be disposed at a position opposite to the neutral region between the first portion 1135a and the second portion 1135b. The neutral portion between the first portion 1135a and the second portion 1135b may be disposed at the outside of the first coil 1151a.

The first portion 1135a of the magnet 1135 may serve as the fifth magnet 1133a in FIG. 11A. The second portion 1135b and the third portion 1135c may be disposed oppositely at the first coil 1151 such that the second portion 1135b and the third portion 1135c may serve as the first magnet 1131a in FIG. 11A. In the illustrated embodiment, the first portion 1135a extends upward (+Z direction) from the second portion 1135b, but this is only an example. In another embodiment the third portion 1135c may extend downward (−Z direction), and in this case, the first position sensor 1171a may be disposed to face the neutral region between the third portion 1135c and the first portion 1135a.

In an embodiment, the camera module 1000 may include the first reflective member 1110 configured to convert a direction of the light L entering from the outside to be directed to the lens module 1200, and a rotational holder 1120 accommodating the reflective member 1110. The camera module 1000 may include a first sub-driver 1101 configured to rotate the rotational holder 1120 about a first axis C1 perpendicular to the optical axis. In an embodiment, the first axis C1 may be perpendicular to the optical axis and may be parallel to a surface perpendicular to the reflective surface 1110a of the first reflective member 1110. For example, the first axis C1 may be parallel to the Z axis. The first axis C1 may be formed by the first ball group 1141.

In an embodiment, the first sub driver 1101 may include a first pair of magnets (the second and fourth magnets 1132a and 1132b) disposed in the rotational holder 1120 to oppose the first axis C1 in a direction perpendicular to the first axis C1. For example, the second magnet 1132a and the fourth magnet 1132b may oppose each other in the X-axis direction.

In an embodiment, the first axis C1 may be disposed between the second and fourth magnets 1132a and 1132b. For example, when viewed in the Z-axis direction, the first axis C1 may be disposed between the second magnet 1132a and the fourth magnet 1132b. As another example, the first axis C1 may be disposed in an area W1 in which the second magnet 1132a and the fourth magnet 1132b oppose each other. As another example, a line CL connecting the centers of the second magnet 1132a and the fourth magnet 1132b may intersect the first axis C1. As another example, when viewed in the Z direction, the line CL connecting the centers of the second magnet 1132a and the fourth magnet 1132b may intersect the first ball group 1141.

In an embodiment, the camera module 1000 may further include the first ball group 1141 arranged along the first axis C1 and supporting the rotation of the rotational holder 1120. In an example embodiment, the rotational holder 1120 may include a supporting portion 1121 on which the first ball group 1141 is seated, and extension portions 1122a and 1122b protruding from both ends of the supporting portion 1121 in a direction parallel to the optical axis. Also, at least a portion of the second and fourth magnets 1132a and 1132b may be disposed on at least a portion of the extension portions 1122a and 1122b. Also, the first ball group 1141 and the rotating plate 1140 may be disposed on at least a portion of a space 1123 between the extension portions 1122a and 1122b.

In an embodiment, the camera module 1000 may further include a second sub-driver 1102 configured to rotate the rotational holder 1120 about a second axis C2 perpendicular to both the optical axis and the first axis C1. The second axis C2 may be directed in a direction perpendicular to both the optical axis and the first axis C1. For example, the second axis C2 may be parallel to the X axis. The second axis C2 may be formed by the second ball group 1142.

In an embodiment, the second sub driver 1102 may include a second pair of magnets (the first and third magnets 1131a and 1131b) disposed in the rotational holder 1120 to oppose the second axis C2 in a direction parallel to the second axis C2. The first and third magnets 1131a and 1131b may oppose each other in the X-axis direction. The first and third magnets 1131a and 1131b may be disposed on both sides of the rotational holder 1120 similarly to the second and fourth magnets 1132a and 1132b, and the first magnet 1131a and the third magnet 1131b may be disposed on the same surface with the second magnet 1132a and the fourth magnet 1132b, respectively. Referring to FIG. 10, the first magnet 1131a and the second magnet 1132a may be spaced apart from each other on the surface of the rotational holder 1120 directed to the +X direction, and the third magnet 1131b and the fourth magnet 1132b may be spaced apart from each other on the surface of the rotational holder 1120 directed to the −X direction. In other words, both the first pair of magnets 1132a and 1132b and the second pair of magnets 1131a and 1131b may be disposed to oppose each other in the X-axis direction.

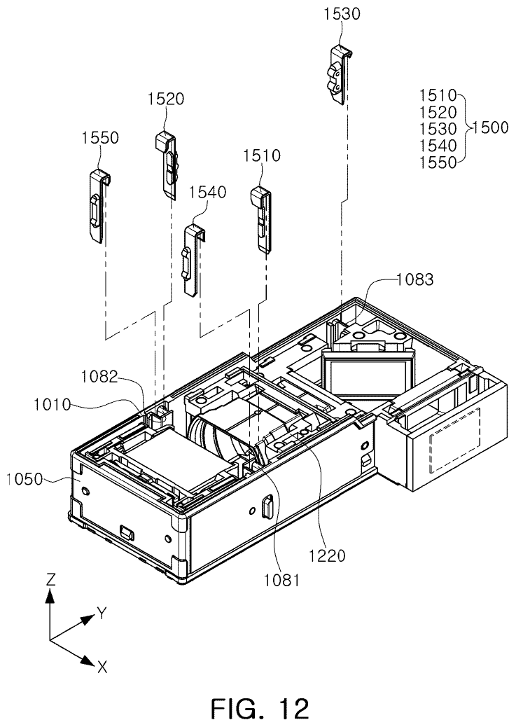

FIG. 12 is a diagram illustrating stoppers disposed in a camera module 1000, according to an embodiment. FIG. 13 is a cross-sectional diagram taken along line IV-IV′ of FIG. 3, and illustrating the camera module 1000. More specifically, FIG. 13 illustrates a cross-sectional surface of the camera module 1000, such that the stopper is shown.

The range in which the folded module 1100 or the lens module 1200 may move within the housing 1010 is limited. The range of movement of the folded module 1100 or the lens module 1200 may be limited by an internal structure of the housing 1010.

Referring to FIG. 12, the housing 1010 may include first, second, and third trap projections 1081, 1082, and 1083 protruding inwardly. When the lens module 1200 moves in the optical axis direction (Y-axis direction), the lens module 1200 may be in contact with the first, second, and third trap projections 1081, 1082, and 1083, such that upper and lower limits of the movement range of the lens module 1200 may be determined. In the illustrated embodiment, the first trap projection 1081 and the second trap projection 1082 may be disposed on one side of the lens module 1200, and the third trap projection 1083 may be disposed on the other side of the lens module 1200. In an embodiment, the first trap projection 1081 and the second trap projection 1082 may also be configured to determine the rotation range of the folded module 1100.

When the lens module 1200 or the folded module 1100 is in the upper or lower limit of the movement range thereof, noise may occur as the element touches the internal structure of the housing 1010. The internal structure of the housing 1010, the lens module 1200, or the folded module 1100 may be damaged due to a large amount of impact or repeated collisions.

In an embodiment, the camera module 1000 may include a stopper 1500 disposed between the housing 1010 and the lens module 1200 (or the folded module 1100) to reduce noise and the amount of impact.

For example, the stopper 1500 may be disposed between the lens module 1200 (or the folded module 1100) and the housing 1010. Even when the lens module 1200 (or the folded module 1100) moves to one side as much as possible, the end of the lens module 1200 (or the folded module 1100) may not directly collide with the housing 1010, and may collide with the stopper 1500. The stopper 1500 may include a material having elasticity, such as rubber or silicone, to work as a buffer.

Referring to FIG. 13, in an example embodiment, the stopper 1500 may include a buffer member (e.g., buffer members 1521 and 1531) and a fastening member (e.g., fastening members 1522 and 1532) for fastening the buffer member to the housing 1010. The fastening members 1522 and 1532 may be coupled to an internal structure of the housing 1010. For example, the buffer members 1521 and 1531 may be formed of rubber, silicone, or the like.

Referring to FIG. 12, the stopper 1500 may include, for example, the first stopper 1510, the second stopper 1520, and a third stopper 1530 disposed on the first trap projection 1081, the second trap projection 1082, and the third trap projection 1083, respectively. For example, the ends (e.g., ends 1220c and 1220d in FIG. 13) of the lens module 1200 may not directly collide with the first, second, and third trap projections 1081, 1082, and 1083 and may collide with the stopper 1500, such that the issues such as noise or damage occurring by the lens module 1200 colliding with the first, second, and third trap projections 1081, 1082, and 1083 may be prevented or inhibited.

Referring to FIG. 12, the stopper 1500 may further include a fourth stopper 1540 and a fifth stopper 1550 disposed on the first trap projection 1081 and the second trap projection 1082, respectively. The end of the folded module 1100 (e.g., 1120a in FIG. 13) may not directly collide with the first and second trap projections 1081 and 1082, and may collide with the fourth and fifth stoppers 1540 and 1550, such that the issues such as noise or damage occurring by the folded module 1100 colliding with the first and second trap projections 1081 and 1082 may be prevented or inhibited.

FIG. 14 is a diagram illustrating a camera module 2000 in which a direction of light is converted one time, according to an embodiment.

Differently from the camera module 1000 in FIGS. 1 to 13, the camera module 2000 in FIG. 14 may not include the reflective module 1400. Light L incident to a folded module 2100 may be converted by about 90 degrees only once and may travel to the image sensor.

The lens module 1200 or the folded module 1100 described with reference to FIGS. 1 to 13 may be also applied to the camera module 2000 illustrated in FIG. 14.

Referring to FIG. 14, a lens module 2200 of the camera module 2000 may be similar to the lens module 1200 described with reference to FIGS. 4A to 8. For example, similarly to FIG. 6, the lens module 2200 may include an asymmetric structure, and at least one support point may be formed between the asymmetric portion and the camera housing. For another example, similarly to FIG. 8, the sensor for sensing the position of the lens module 2200 may be disposed to not oppose the driving magnet.

Also, the folded module 2100 of the camera module 2000 may be similar to the folded module 1100 described with reference to FIGS. 9 to 11. For example, the driving magnets (e.g., the first magnet 1131a and the second magnet 1132a in FIG. 9) responsible for the rotation of the folded module 2100 about the X-axis and the Z-axis may be provided in the folded module 2100 to be directed to the same direction. As another example, the folded module 2100 may include a magnet for sensing a position (e.g., the fifth magnet 1133a in FIG. 9).

FIG. 15 is a diagram illustrating the electronic device 1, according to an embodiment.

Referring to FIG. 15, the electronic device 1 may be a portable electronic device, a smart phone, a tablet PC, or the like, including the first camera module 100 (e.g., the camera module 1000 in FIG. 1 or the camera module 2000 in FIG. 14).

In the example embodiment, the optical axis of the lens module in the first camera module 100 may extend in a direction perpendicular to the thickness direction of the portable electronic device 1. For example, the thickness direction may be a direction from a front surface (e.g., a display surface) of the electronic device 1 to a rear surface of the electronic device, and vice-versa.

Therefore, even when the first camera module 100 includes functions such as autofocusing (hereinafter, AF), zooming, and optical image stabilization (hereinafter, OIS), the thickness of the portable electronic device 1 may not increase. Accordingly, the size of the portable electronic device 1 may be reduced.

In an embodiment, the portable electronic device 1 may include two or more camera modules to image an object. For example, the portable electronic device may further include the second camera module 200 in addition to the first camera module 100.

When the two camera modules 100 and 200 are used, entrance holes through which light is incident to the two camera modules 100 and 200 may be disposed adjacent to each other. Alternatively, the positions of the first camera module 100 and the second camera module 200 may be switched.

In an embodiment, the first camera module 100 and the second camera module 200 may be configured to have different fields of view. The first camera module 100 may be configured to have a relatively narrow field of view (e.g., a telephoto camera), and the second camera module 200 may be configured to have a relatively wide field of view (e.g., a wide-angle camera).

According to the aforementioned embodiments, a camera including the first camera module 100 and the second camera module 200 may provide images of excellent quality, excellent optical image stabilization and autofocusing functions may be provided, and the camera module may have a reduced size and thickness.

Also, even in a camera module providing a high zoom magnification, a focus adjustment function or a zoom magnification adjustment function may be stably performed. Also, the driving elements necessary for the optical image stabilization function may be configured to not interfere with the other electronic components disposed in the electronic device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a housing;
a lens module configured to move in an optical axis direction in the housing;
a first magnetic member disposed in the lens module;
a reflective member configured to reflect light from the lens module to an output direction perpendicular to the optical axis direction; and
a second magnetic member disposed to oppose the first magnetic member in the housing,
wherein the lens module is attached to one surface of the housing by magnetic attraction force arising between the first magnetic member and the second magnetic member,
wherein the lens module is supported at three support points by three ball members disposed between the lens module and the housing,
wherein the first magnetic member is disposed in the lens module such that the first magnetic member is disposed in a triangle formed by virtual lines connecting the three ball members to each other,
wherein the lens module comprises a first support structure extending in the optical axis direction configured to move behind and overlap with the reflective member in the output direction, and
wherein one of the three support points is disposed on the first support structure.

2. The camera module of claim 1, wherein a center of the first magnetic member is disposed in the triangle.

3. The camera module of claim 1, wherein the lens module includes guide grooves configured to guide the three ball members, respectively, in a direction parallel to the optical axis.

4. The camera module of claim 1, wherein the lens module includes a second support structure disposed opposite to the first support structure and extending in the optical axis direction, wherein two ball members among the three ball members are disposed between the first support structure and the housing, and another ball member among the three ball members is disposed between the second support structure and the housing,
wherein the first support structure includes an extension portion protruding farther than the second support structure in the optical axis direction, and
wherein one of the two ball members disposed between the first support structure and the housing is disposed between the extension portion and the housing.

5. The camera module of claim 4, wherein the first magnetic member is disposed more adjacent to the first support structure than the second support structure.

6. The camera module of claim 4, wherein the lens module includes a lens barrel including at least one lens, and a lens holder accommodating the lens barrel, and
wherein the extension portion is a portion of the lens holder.

7. The camera module of claim 6, wherein the lens barrel is symmetric with respect to a plane that includes the optical axis and is perpendicular to a direction in which the first and second support structures oppose each other.

8. The camera module of claim 1, further comprising:
a magnet disposed in the lens module;
a coil opposing the magnet; and
a position sensor disposed on an external side of the coil.

9. The camera module of claim 1, further comprising:
another reflective member configured to convert a direction of light entering from the outside to a direction toward the lens module;
a rotational holder accommodating another reflective member; and
a first driver configured to rotate the rotational holder about a first axis perpendicular to the optical axis,
wherein the first driver includes first magnets disposed in the rotational holder such that the first magnets oppose each other in a direction perpendicular to the first axis, and the first axis is disposed between the first magnets.

10. The camera module of claim 9, wherein the first axis is perpendicular to the optical axis and is parallel to a surface perpendicular to a reflective surface of the other reflective member.

11. The camera module of claim 9, further comprising:
ball members arranged along the first axis and supporting rotation of the rotational holder,
wherein the rotational holder includes a supporting portion on which the ball members are seated, and an extension portion protruding from ends of the supporting portion in a direction parallel to the optical axis, and
wherein at least a portion of the pair of first magnets is disposed in the extension portion.

12. The camera module of claim 9, further comprising:
a second driver configured to rotate the rotational holder about a second axis perpendicular to both the optical axis and the first axis,
wherein the second driver includes second magnets disposed in the rotational holder such that the second magnets oppose each other in a direction parallel to the second axis.

13. The camera module of claim 12, wherein the second magnets include a third magnet, and
wherein the second driver further includes a fifth magnet spaced apart from the third magnet, a coil opposing the third magnet, and a position sensor opposing a boundary between the third magnet and the fifth magnet.

14. The camera module of claim 13, wherein the fifth magnet is spaced apart from the third magnet in a circumferential direction with respect to the second axis.

15. The camera module of claim 1, further comprising:
another reflective member configured to convert a direction of light entering from the outside to a direction toward the lens module.

16. A camera module, comprising:
a housing;
a lens module configured to move back and forth in an optical axis direction with respect to the housing, in the housing;
a reflective member configured to reflect light from the lens module to an output direction perpendicular to the optical axis direction;
a first magnetic member disposed in the lens module; and
a second magnetic member disposed in the housing and opposing the first magnetic member,
wherein the lens module is attached to the housing in a first direction perpendicular to the optical axis by magnetic attraction force between the first magnetic member and the second magnetic member, and is supported in the first direction by three support points,
wherein the first magnetic member is disposed in a triangle formed by virtual lines connecting the three support points to each other while the lens module moves in the optical axis direction, in a view in the first direction,
wherein the lens module comprises a first support structure extending in the optical axis direction configured to move behind and overlap with the reflective member in the output direction, and
wherein one of the three support points is disposed on the first support structure.

17. The camera module of claim 16,
wherein the lens module includes a second support structure disposed opposite to the first support structure and extending in the optical axis direction,
wherein two support points among the three support points are disposed between the first support structure and the housing, and another support point among the three support points is disposed between the second support structure and the housing,
wherein the first support structure includes an extension portion protruding farther than the second support structure in the optical axis direction, and
wherein one of the two support points disposed between the first support structure and the housing is disposed between the extension portion and the housing.

18. The camera module of claim 17, wherein the lens module further includes a lens barrel including at least one lens, and a lens holder accommodating the lens barrel, and wherein the extension portion is a portion of the lens holder.

19. A camera module, comprising:
a housing;
a lens module disposed in the housing and configured to move with respect to the housing along an optical axis of the lens module;
a reflective member configured to reflect light from the lens module to an output direction perpendicular to the optical axis direction;
a first magnetic member disposed in the lens module; and
a second magnetic member disposed in the housing and opposing the first magnetic member,
wherein the lens module is attached to the housing in a first direction perpendicular to the optical axis by magnetic attraction force between the first magnetic member and the second magnetic member, and is supported in the first direction by three support points,
wherein, throughout an entire movement range of the lens module along the optical axis, the first magnetic member is disposed in a triangle formed by virtual lines connecting the three support points to each other in a plane perpendicular to the first direction,
wherein the lens module comprises a first support structure extending in the optical axis direction configured to move behind and overlap with the reflective member in the output direction, and
wherein one of the three support points is disposed on the first support structure.

20. The camera module of claim 19, wherein two support points among the three support points are disposed on one side of the optical axis, in a direction perpendicular to the first direction, and
wherein another support point among the three support points is disposed on another side of the optical axis, in the direction perpendicular to the first direction.

21. The camera module of claim 20, wherein the two support points engage a first support structure of the lens module disposed on the one side of the optical axis,
wherein the other support point engages a second support structure of the lens module disposed on the other side of the optical axis, and
wherein one of the two support points engages a portion of the first support structure extending beyond the second support structure in an image-side direction of the optical axis.

22. The camera module of claim 19, wherein the three support points are formed by ball members disposed between the lens module and the housing.
